(19) United States
(12) Patent Application Publication
(10) Pub. No.: US 2026/0318775 A1
(43) Pub. Date: Oct. 15, 2026

(54) Method and Apparatus for Performing Correlation Optical Time Domain Reflectometry on an Optical Fibre

(71) Applicant: Telefonaktiebolaget LM Ericsson (publ), Stockholm (SE)

(72) Inventors: Davide Sanguinetti, Genova (IT); Roberto Magri, Genova (IT); Valentina Pastorello, Genova (IT)

(21) Appl. No.: 19/482,909

(22) PCT Filed: May 3, 2024
(86) PCT No.: PCT/EP2024/062366

§ 371 Date: Nov. 10, 2025

Related U.S. Application Data
(60) Provisional application No. 63/501,711, filed on May 12, 2023.

(51) Int. Cl. G01M 11/00

(52) U.S. Cl. CPC G01M 11/3118; G01M 11/3127; G01M 11/3145

(57) ABSTRACT

The present disclosure relates to a method (10) for performing correlation optical time domain reflectometry (OTDR) on an optical fibre (220), and an OTDR apparatus (20). The method comprises generating (S101) a first signal, wherein the first signal comprises a sequence of optical radiation pulses based on a coded sequence, wherein the coded sequence comprises at least a first block and a second block, the first block comprising a plurality of repetitions of a first subsequence, and the second block comprising a plurality of repetitions of a second subsequence. The method further comprises transmitting (S102) the first signal and receiving a returned signal. The method also comprises discarding (S103) at least one of the repetitions of the subsequences in the returned signal to leave at least one remaining repetition of the subsequences, and correlating (S104) the remaining repetitions with the first signal to obtain an OTDR measurement of the optical fibre.

### TECHNICAL FIELD

The present application relates to a method, apparatus and computer program product for performing correlation optical time domain reflectometry (OTDR) on an optical fibre. The present application also relates to an optical plug for providing a connection between a transceiver and an optical fibre. The present application further relates to a transceiver.

### BACKGROUND

OTDR is a technique that may be used to characterise an optical fibre, for example, to detect, analyse and/or diagnose faults. The principle of operation measures the round-trip time (RTT) that the transmitted and then reflected train of light pulses takes to travel along the optical fibre. Using the RTT and knowledge of the speed of the light pulses in the fibre, it is possible to identify the distance (obtained from the time of the reflected signal) at which a particular event occurred and the type of event (obtained principally from the pulse amplitude), such as connections or fibre breaks. OTDR can locate imperfections along an optical fibre by measuring the round-trip travel time of an optical radiation pulse reflected and/or backscattered from sites along the fibre. The optical pulse may be backscattered from scattering sites which result due to imperfections in the optical fibre. The optical pulse may also be reflected from points along the fibre, which may result from, for example, an optical fibre splice.

Traditional OTDR presented a trade-off between resolution and dynamic range by adjusting the duration of the optical pulse transmitted into an optical fibre. This problem has been solved by correlation OTDR where long coded sequences of narrow pulses replace single high power and wide pulses. Time resolution of below 1 ns has been demonstrated by correlation OTDR. Due to this time performance, correlation OTDR has been proposed to precisely measure the one-way fibre latency characteristics of optical fibres and support fibre latency asymmetry calibration, which are both required for optical fibres for 5G RAN applications where nanosecond accuracy is desired.

A paper entitled “Latency Measurement of 100 km Fiber Using Correlation-OTDR” by Azendorf et al, 20th ITG-Symposium Photonic Networks 2019 discloses a correlation OTDR technique operating without an analogue-to-digital converter (ADC) at 2.5 Gb/s to achieve a sub-ns resolution. A terminal reflector is used at the end of the fibre in order to guarantee that a sufficiently strong reflection can be detected as a demarcation point.

### SUMMARY

It is an aim of the present disclosure to provide a method, an apparatus and a computer program product that which at least partially address one or more of the challenges discussed herein.

The present disclosure provides a method for performing correlation OTDR on an optical fibre. The method comprises generating a first signal, wherein the first signal comprises a sequence of optical radiation pulses based on a coded sequence, said coded sequence comprising at least a first block and a second block. The first block comprises a plurality of repetitions of a first subsequence, and the second block comprises a plurality of repetitions of a second subsequence. The method further comprises transmitting the first signal into an optical fibre, and receiving a returned signal of optical radiation backscattered and/or reflected from the optical fibre. The method also comprises discarding at least one of the repetitions of the subsequences in the returned signal to leave at least one remaining repetition of the subsequences, and correlating the at least one remaining repetition of the subsequences with the first signal to obtain an OTDR measurement of the optical fibre.

The present disclosure also provides an OTDR apparatus for performing correlation OTDR on an optical fibre. The OTDR apparatus comprises processing circuitry, a memory containing instructions executable by the processing circuitry, and one or more interfaces. The OTDR apparatus is operable to generate a first signal, wherein the first signal comprises a sequence of optical radiation pulses based on a coded sequence, said coded sequence comprising at least a first block and a second block. The first block comprises a plurality of repetitions of a first subsequence, and the second block comprises a plurality of repetitions of a second subsequence. The OTDR apparatus is further operable to transmit the first signal into an optical fibre, and receive a returned signal of optical radiation backscattered and/or reflected from the optical fibre. The OTDR apparatus is also operable to discard at least one of the repetitions of the subsequences in the returned signal to leave at least one remaining repetition of the subsequences, and correlate the at least one remaining repetition of the subsequences with the first signal to obtain an OTDR measurement of the optical fibre.

The scope of the disclosure is defined by the claims.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flowchart of a method in accordance with embodiments;

FIG. 2A and FIG. 2B are schematic diagrams of OTDR apparatuses in accordance with embodiments;

FIG. 3 is a signal diagram showing transmitted and received signals in accordance with some embodiments;

FIG. 4 is a further OTDR apparatus in accordance with embodiments;

FIG. 5 is a diagram showing an example of signal delay and repetition in accordance with some embodiments;

FIG. 6 is schematic diagram of a data acquisition and storage system in accordance with some embodiments;

FIG. 7A is a plot showing an example of transmitted and received pulses in a classical OTDR apparatus;

FIG. 7B is a plot showing an example of transmitted and received pulses in a D-OTDR apparatus, in accordance with embodiments;

FIG. 8A is an example of a D-OTDR trace obtained using normal subsequences, in accordance with embodiments;

FIG. 8B is an example of a D-OTDR trace obtained using differential subsequences, in accordance with embodiments;

FIG. 9 is a plot illustrating the use of oversampling;

FIG. 10A is a plot showing measurement and correlation results in accordance with some embodiments; and

FIG. 10B is a plot showing the results obtained following integration of the FIG. 10A results.

### DETAILED DESCRIPTION

The present disclosure relates to methods and apparatus for performing correlation OTDR on an optical fibre, which may address one or more of the above challenges.

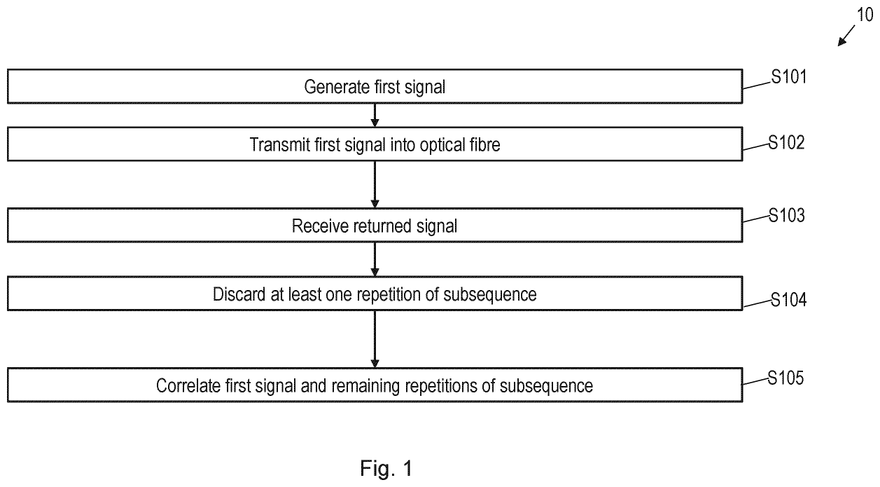

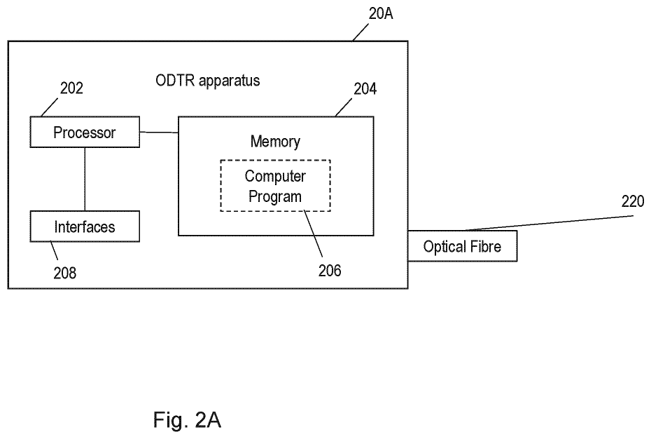

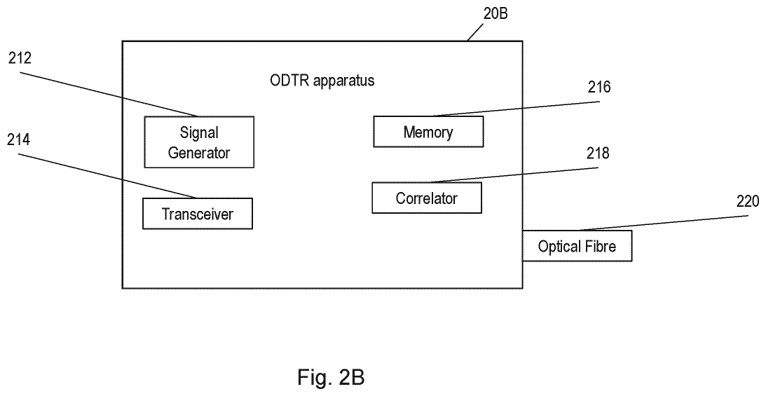

FIG. 1 is a flowchart of a method 10 in accordance with embodiments. The method may be performed by any suitable apparatus. Examples of suitable apparatus for performing the method shown in FIG. 1 are the OTDR apparatuses 20A and 20B shown schematically in FIG. 2A and FIG. 2B respectively; OTDR apparatuses 20A and 20B may collectively be referred to using reference sign 20. The method may also be performed by any other suitable component or components, such as a further OTDR apparatus. The OTDR apparatus 20A as shown in FIG. 2A may execute steps of the method in accordance with a computer program stored in a memory 204, executed by a processor 202 in conjunction with one or more interfaces 208. The OTDR apparatus 20B may execute steps of the method using signal generator 212, transceiver 214, memory 216 and correlator 218. The OTDR apparatuses 20A and 20B may also be configured to execute the steps of other embodiments, as discussed in detail below. Typically, although not necessarily, the OTDR apparatus may form part of an optical communications network.

In step S101, a first signal is generated (for example by OTDR apparatus 20). The first signal comprises a sequence of optical radiation pulses based on a coded sequence, wherein the coded sequence comprises at least a first block and a second block. The first block comprises a plurality of repetitions of a first subsequence, and the second block comprises a plurality of repetitions of a second subsequence. The optical radiation pulses are used to represent binary information, accordingly pulses having two different amplitude levels (to represent binary 1 and 0) are used. The bits of the binary information may be non-return-to-zero (NRZ) encoded, such that it is not necessary for either of the amplitude levels to be zero amplitude.

The coded sequence may be based on a codeword. Where the codeword is a bipolar codeword, the first and second subsequences may be based on a pair of unipolar codewords derived from the bipolar codeword. In some embodiments, the coded sequence may be further based on a second codeword; for which the coded sequence further comprises a third block and a fourth block. In such embodiments, the third block may comprise a plurality of repetitions of a third subsequence, and the fourth block may comprise a plurality of repetitions of a fourth subsequence. In some embodiments, the second codeword may be a further bipolar codeword and the third subsequence and fourth subsequence may be a pair of further unipolar codewords derived from the further bipolar codeword. As an example where the second code word is a further bipolar codeword, the first codeword and second codeword may be a pair of complementary Golay sequences. For example, where first and second codewords are used, the codewords are based on sequences with good autocorrelation properties (a further example are based on Psuedo Random Binary Sequences, PRBS). In alternative embodiments where a second codeword is not used (or, alternatively, where the second codeword is the same as the first codeword), the first codeword may be based on a Linear Feedback Shift Register (LFSR), for example.

Continuing with example embodiments in which complementary Golay sequences are used as the first and second codewords; as Golay sequences have the property that their out-of-phase aperiodic autocorrelation coefficients sum to zero, by correlating the measurement signal with the one or more codewords, the correlation signal may indicate points at which the signal is non-zero and points in the signal at which the measurement signal contains a codeword. This is therefore indicative of a point within the optical fibre at which some reflection or backscatter has occurred.

Thus, as one skilled in the art will be familiar with, the Golay codewords correlate to a Dirac delta function:

g×g=δ
where g is the Golay codewords and δ represents a Dirac delta function.

A first signal comprising radiation pulses based on a Golay codeword may thus be transmitted into an optical fibre and the signal of radiation reflected and/or backscattered from within the optical fibre is thus the convolution between a Golay codeword sequence and twice the fibre response. The fibre response identifies the locations of reflection and scattering sites along the fibre, as well as information on the attenuation of the optical fibre:

r=g*h
Where r is the signal of radiation reflected and/or backscattered from within the optical fibre, g is a Golay codeword and h is twice the fibre response.

A cross correlation between the transmitted and received signal can thus be performed according to:

g×r=g×(g*h)=(g×g)*h=h

The response of the fibre h can thus be obtained from the cross correlation because the sequences of the Golay codewords correlate to a Dirac delta function. Thus, through use of the Golay sequences and correlation OTDR techniques, the response of the fibre including the locations of reflections and scattering sites as well as attenuation can be obtained. Circular cross correlation is discussed in greater detail below.

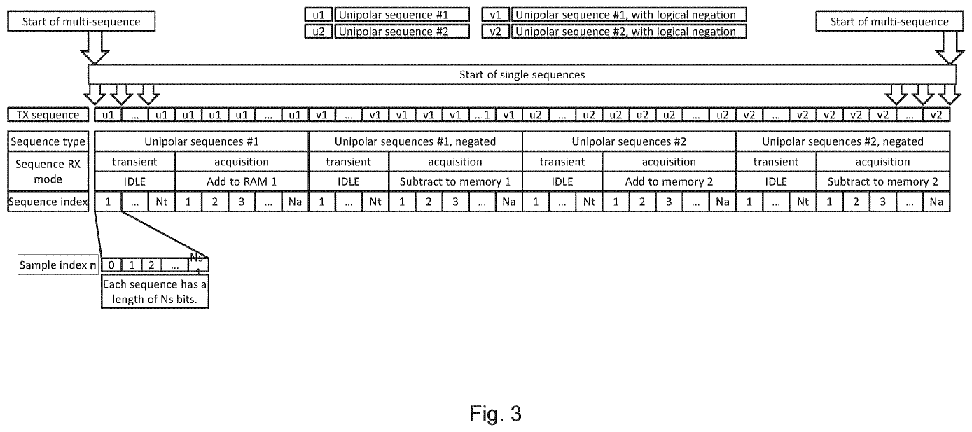

FIG. 3 is a signal diagram showing an example of the transmission of a first signal and reception of a received signal, each of which include first, second, third and fourth subsequences in accordance with some embodiments. In some embodiments the first signal is transmitted as a DC signal. In the FIG. 3 example, a sequence generator sends sequences of length Ns bits and duration Ts=Ns/Fs, where Fs is the sampling frequency. Ts is the maximum delay allowed for reflected signals, and hence determines the length of optical fibre upon which OTDR may be performed. Ts is determined in part by the values of Ns and Fs (as well as the speed of the signals in the fibre, which is a function of refractive index). By way of example, with Fs=250 MHz and Ns=217 the maximum delay is 524288 ns. With a refraction index of 1.468 the maximum distance reached is about 53.5 Km.

In the FIG. 3 example, the first, second, third and fourth subsequences are based on a pair of complementary Golay sequences, referred to here as g1 and g2. Accordingly, two sequences g1 and g2, of length Ns, are to be sent. In this example, g1 and g2 are bipolar sequences:

g1=[+1 +1 +1 −1 +1 +1 −1 +1], g2=[+1 +1 +1 −1 −1 −1 +1 −1].

For transmission, each of the bipolar sequences is used to generate two unipolar sequences (which may then be transmitted), one of which is a logically negated sequence. The combination of the unipolar sequences can be used to regenerate the bipolar sequence. Continuing with the FIG. 3 example, the unipolar sequences are:

u1=[1 1 1 0 1 1 0 1], u2=[1 1 1 0 0 0 1 0],
and after logical negation:

v1=[0 0 0 1 0 0 1 0], v2=[0 0 0 1 1 1 0 1].

The first signal indicated in FIG. 3 is formed using repetitions of the four unipolar sequences u1, v1, u2, v2. The repeated sequences u1, v1, u2, v2 may be referred to as subsequences. Each sequence is repeated Nt+Na times, where Nt is the number of repetitions of each of the subsequences in the returned signal that are discarded (the idle subsequences) and Na is the number of repetitions of each of the subsequences in the returned signal that are not discarded (the active subsequences). In some embodiments, the first signal may be repeated multiple times to improve the signal to noise ratio. If Nr is the number of first signals sent, then the total number of active subsequences sent is Na·Nr.

In alternative embodiments, instead of complementary bipolar sequence pairs, the coded sequence is based on subsequences generated by a different type of method, e.g. LFSR. In one example, the coded sequence (i.e. first signal) uses only a single sequence type. In case of only one sequence type, there is no distinct u2 or v2 sequence, i.e. u2=u1. In this example, same pair of unipolar sequences (i.e. u1 and v1) are repeated, without a repeated subsequence based on a different sequence. The sequences may already be unipolar in this case. To have perfectly balanced sequences, it is possible to generate them by sending each bit of the unipolar sequence twice, the second with a logical negation. Balanced sequences may be well suited for AC coupled RX electrical paths. Alternatively, the subsequences are generated by a different type of method than Golay sequences (e.g. LFSR) and use one or more different sequences to generate the repeated subsequences.

Where an OTDR apparatus 20A in accordance with the embodiment shown in FIG. 2A is used, the generation of the first signal may be performed in accordance with a computer program 206 stored in a memory 204, executed by a processor 202 in conjunction with one or more interfaces 208. Alternatively, where an OTDR apparatus 20B in accordance with the embodiment shown in FIG. 2B is used, the generation of the first signal may be performed by the signal generator 212.

As shown in FIG. 1, in step S102, the first signal is transmitted into the optical fibre 220 (for example by OTDR apparatus 20). Where an OTDR apparatus 20A in accordance with the embodiment shown in FIG. 2A is used, the transmission of the first signal may be performed in accordance with a computer program 206 stored in a memory 204, executed by a processor 202 in conjunction with one or more interfaces 208 (for example, including a laser diode). Alternatively, where an OTDR apparatus 20B in accordance with the embodiment shown in FIG. 2B is used, the transmission of the first signal may be performed by the transceiver 214.

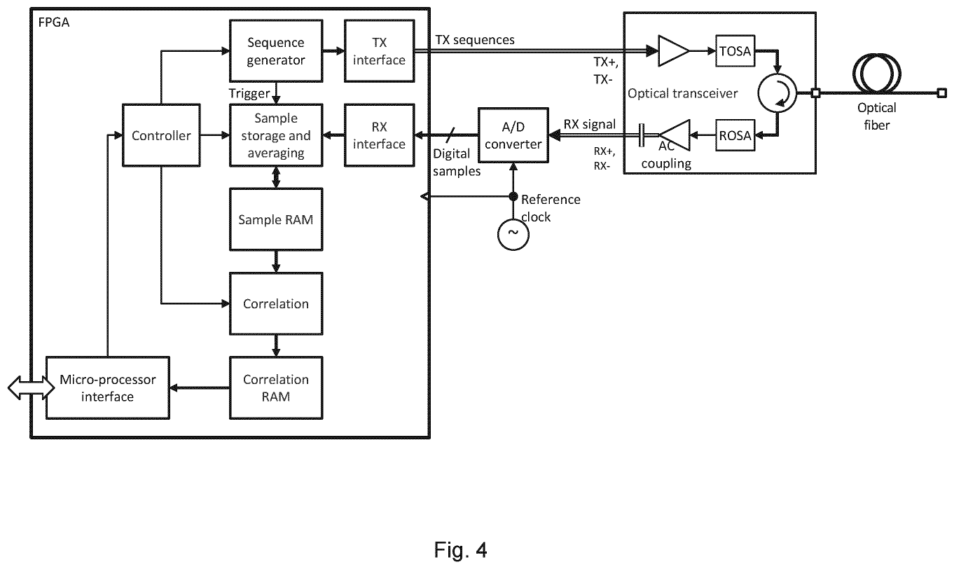

A further OTDR apparatus in accordance with embodiments is shown in FIG. 4. In the FIG. 4 example, a field programmable gate array (FPGA) is used that comprises various components, including a sequence generator. The sequence generator may be used to generate the first signal (optionally under instructions from the controller and/or microprocessor interface), and in particular may continuously sends binary patterns at rate Fs to the TX interface and sends a trigger signal to align the received data. In alternative embodiments, an application specific integrated circuit (ASIC) or any type of processing circuitry may fulfil the role of the FPGA in FIG. 4. The generated first signal is then sent to the transmission (TX) interface and on to the optical transceiver. In some embodiments the TX interface may be a differential serial interface (as shown in FIG. 4). The interface may work at an oversampled rate, to allow fine tuning of the output delay of the sequence.

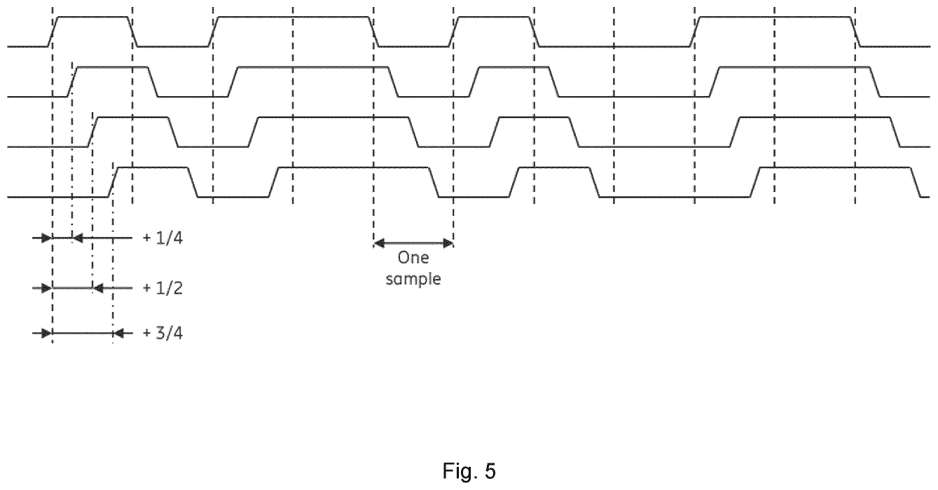

In some embodiments, an oversampling is used for the transmission of the OTDR signal. The transmission of the first signal comprises generating a plurality of copies of the first sequence, applying different delays to the plural copies, and transmitting the plural copies. In some examples, the delays applied to the plural copies are determined based on an oversampling ratio, which is a ratio between a transmission frequency of a transmitter used to transmit the first signal and a sampling frequency of a receiver used to receive the returned signal. By way of example, if the interface works with an oversampling ratio of 4, each bit of the transmitted sequence will be repeated four times, at a bit rate of Fs*4. The internal logic can delay the bits by 0, 1, 2, and 3, corresponding to a delay of 0, ¼, ½, and ¾ of a sample; an example of signal delay and repetition, in accordance with embodiments, is shown in FIG. 5.

The optical transceiver comprises a transmit optical sub-assembly (TOSA) that converts the (electrical) signal from the FPGA into an optical signal to be sent into the optical fibre (for example, using a laser diode). The optical transceiver also comprises a receive optical sub-assembly (ROSA) that performs the reverse conversion on the returned (reflected and/or backscattered) signal, which may be received using any suitable receiver such as a photodiode. The optical transceiver also comprises an integrated optical circulator or splitter and linear RX amplifier. Continuing with the FIG. 4 example, an Analog to Digital (A/D) converter samples and quantizes the received electrical signal from the optical transceiver and passes this to the reception (RX) interface of the FPGA. The received signal is then sampled and stored by the sample storage and averaging module of the FPGA, using the sample RAM. The correlation and correlation RAM modules are used in the correlation process, the results of which are passed to the micro-processor interface. The process may be performed under the control of the controller, which may control all the phases of D-OTDR measurement. An input from a user may be used as a trigger to starts D-OTDR, alternatively the apparatus itself may schedule this. Then the acquisition process starts by storing and summing samples several sequences to improve the signal to noise ratio. At the end of acquisition, the controller starts the correlation of received, averaged sequences with the transmitted sequences, to obtain the OTDR measurement.

When the first signal has been inputted into the optical fibre, and reflected/backscattered, the method shown in FIG. 1 then continues with the receiving of a returned signal of optical radiation backscattered and/or reflected from the optical fibre, as shown in step S103. As discussed above, in the example OTDR apparatus shown in FIG. 4 the optical transceiver may be used to receive the signal. Where an OTDR apparatus 20A in accordance with the embodiment shown in FIG. 2A is used, the reception of the signal may be performed in accordance with a computer program 206 stored in a memory 204, executed by a processor 202 in conjunction with one or more interfaces 208 (for example, including a photodiode). Alternatively, where an OTDR apparatus 20B in accordance with the embodiment shown in FIG. 2B is used, the reception of the signal may be performed by the transceiver 214.

The method of FIG. 1 then continues with the step of discarding at least one of the repetitions of each of the subsequences in the returned signal, as shown in S104. Typically, the repetitions of each of the subsequences in the returned signal that are discarded comprise the earliest received repetition in each block of the subsequences, (the discarded subsequences may be referred to as idle subsequences), as shown in FIG. 3. As mentioned previously, the time for the idle subsequences in each block to be received is typically greater than or equal to the RTT for the first signal in the optical fibre. Additionally or alternatively, the time for the repetitions of each of the subsequences in the returned signal that are not discarded (that is, the active subsequences) to be received may be greater than or equal to the RTT for the first signal in the optical fibre. Additionally or alternatively, the time for the subsequences in the returned signal may be greater than or equal to the RTT for the first signal in the optical fibre. References to the time of the subsequences may refer to a time duration of the subsequences. References to the RTT may refer to a maximum RTT, e.g. based on the maximum length of the optical fibre between nodes. In this way, collisions between signals may be avoided and the circular cross correlation may be performed as discussed below.

Where an OTDR apparatus 20A in accordance with the embodiment shown in FIG. 2A is used, the discarding of subsequence repetition(s) may be performed in accordance with a computer program 206 stored in a memory 204, executed by a processor 202 in conjunction with one or more interfaces 208. Alternatively, where an OTDR apparatus 20B in accordance with the embodiment shown in FIG. 2B is used, the discarding of subsequence repetition(s) may be performed by the transceiver 214 in conjunction with the memory 216.

The subsequences in the returned signal that are not discarded (the remaining subsequences) are then stored and correlated with the subsequences from the first signal, to obtain an OTDR measurement of the optical fibre (as shown in step S105 of FIG. 1). Where an OTDR apparatus 20A in accordance with the embodiment shown in FIG. 2A is used, the correlation may be performed in accordance with a computer program 206 stored in a memory 204, executed by a processor 202 in conjunction with one or more interfaces 208. The correlation (or combining) of the transmitted signal and part of the received signal provides for an output signal which indicates the position of the backscattering/reflection, which can indicate the location of a break or fault in the optical fibre. Alternatively, where an OTDR apparatus 20B in accordance with the embodiment shown in FIG. 2B is used, the correlation may be performed by the correlator 218.

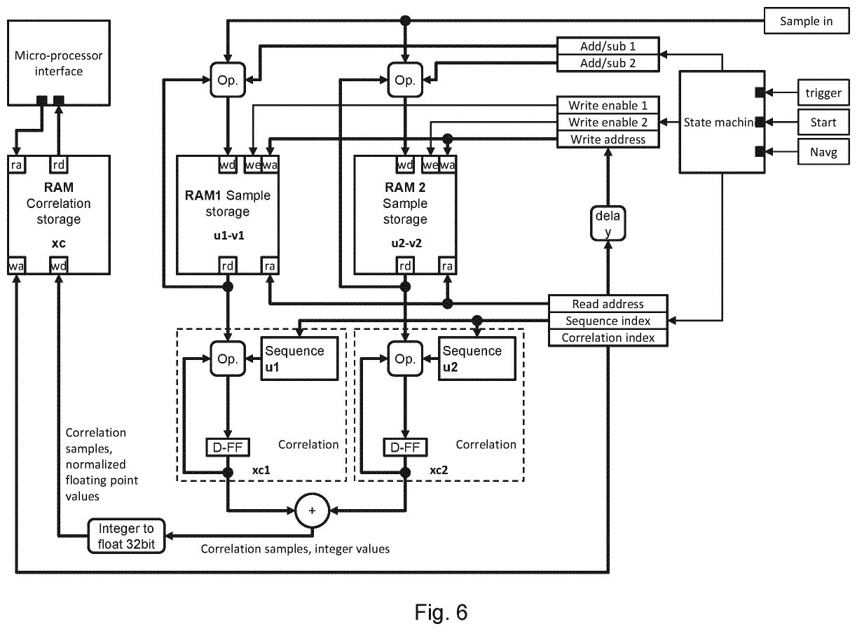

A detailed schematic diagram of a data acquisition and storage apparatus, in accordance with some embodiments, is shown in FIG. 6. Continuing with the example discussed above with reference to FIG. 3 and FIG. 4, digital samples received from an A/D converter may be stored into RAM banks. At the beginning of an acquisition, the RAM banks (or alternative memory units) may be reset to zero values, then data may be stored according to the status of sequence transmission, as shown in FIG. 3. In particular, and with reference to the FIG. 3 example and the FIG. 6 schematic diagram:
When transmitting u1 sequences, add values to RAM 1.
When transmitting v1 sequences, subtract values to RAM 1.
When transmitting u2 sequences, add values to RAM 2.
When transmitting v2 sequences, subtract values to RAM 2.

RAM 1 will then contain the bipolar codeword g1, and RAM 2 will contain the bipolar codeword g2; in this example g1 and g2 are complementary Golay sequences. The add/subtract operations are typically done only during acquisition phases; during transients (such as when idle sequences are received) no modifications are made to the RAM contents. Sending sequences with logical negation may provide balanced results even if the receive path has asymmetries, such as a residual DC level on a received signal. Each RAM bank may be composed of at least Ns locations. At the end of data acquisition, the two RAM banks will contain two received sequences:
r1(i) to be correlated to g1
r2(i) to be correlated to g2
   for i=0 to Ns−1

Each value is the sum of Na·Nr samples received from ADC. To average the sequences, the sequences are divided by the same number.

Circular cross correlation may then be performed using the transmitted and received sequences, to obtain the OTDR measurement. Circular cross-correlation may be determined using:

$$ccorr ( i ) = {\sum }_{n = 0}^{Ns - 1} r ( mod ( i + n , Ns ) ) \cdot t ( n ) for i = 0 to Ns - 1$$

Where r(i) is the received sequence and t(i) is the transmitted sequence. Where complementary sequences are used, the resulting correlation is performed as

$$x c = \frac{ccorr ( r 1 , g 1 ) + c c o r r ( r 2 , g 2 )}{Ns \cdot 2}$$

The division by Ns·2 is required to normalize the correlation, so that
xc(0)=1 and xc(i)=0 for i=0 to Ns−1
when r1=g1 and r2=g2.

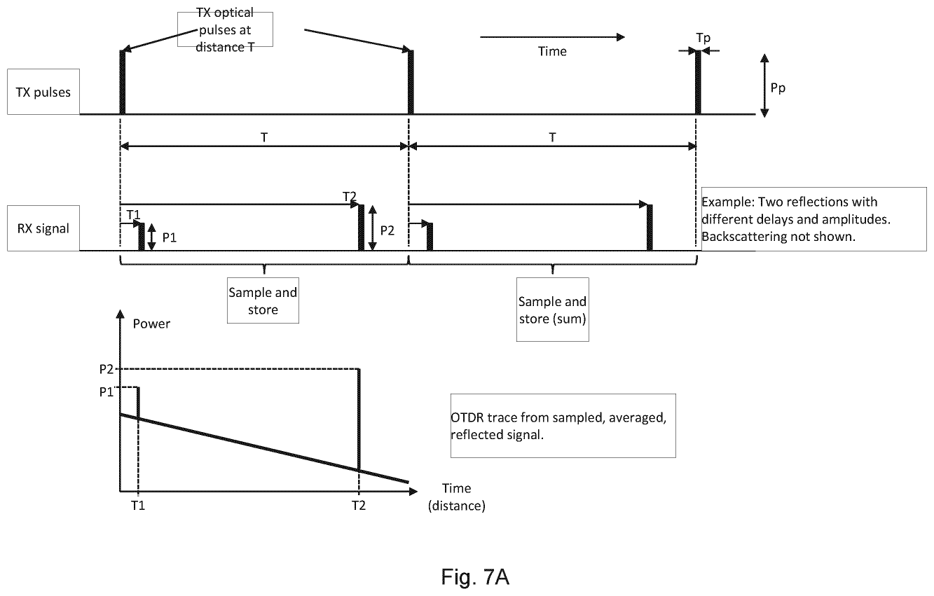

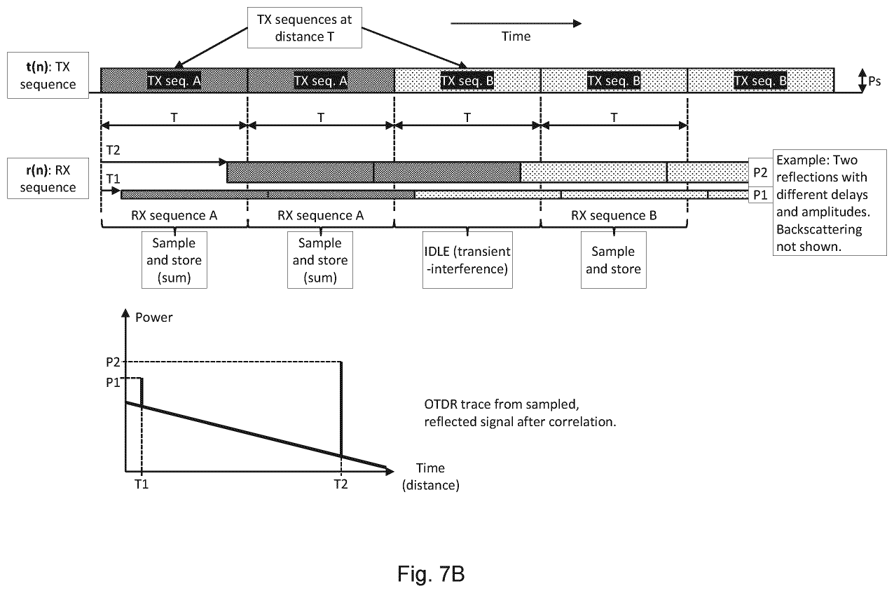

The correlation process may be done, for example, using processor 202, memory 204 and interfaces 208, using correlator 218, inside a FPGA/ASIC or offline by reading the values from memory (for example, sample storage RAMs). The OTDR measurement results obtained may then be used to identify potential issues in the optical fibre, similarly to the way in which results from classical OTDR are used. FIG. 7A shows the transmitted pulses and received signal in a classic OTDR apparatus (in which discrete, short duration and intense optical pulses are used). In the FIG. 7A example, two reflection points in the fibre are shown, indicating issues (for example, cracks) at two points in the fibre. The amplitude of the return pulse is related to the severity of the fibre issues, with larger return pulses for more serious issues. FIG. 7B shows equivalent results for a D-OTDR apparatus (in accordance with embodiments), again where two reflection points are detected; the location of the reflection points is indicated by constructive interference spikes between the first signal and returned signal, as identified using the circular cross correlation.

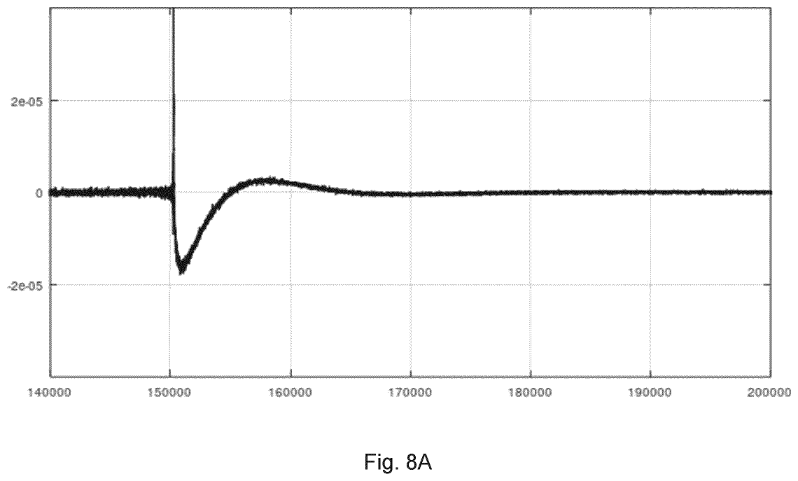

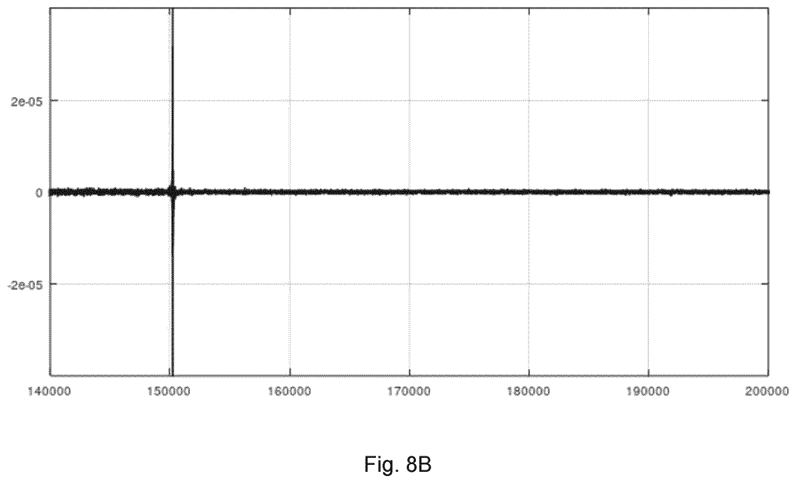

In some embodiments, the subsequences may be differentiated to generate differential subsequences before transmission, and the cross-correlation may then be performed between the differential subsequences transmitted in the first signal and differential subsequences received in the returned signal. The use of differential subsequences may improve OTDR measurements obtained. Optical transceivers typically remove DC content from RX electrical signal; this process is analogous to a differentiation of correlation result; backscattering is removed and only reflection points are detected. Also, typically after reflection points there are damped oscillations that reduce the clarity of obtained results; this issue may also be mitigated through the use of differential subsequences. FIG. 8A shows a D-OTDR measurement (in this example a trace) obtained utilizing normal (not differential) subsequences in accordance with some embodiments; the damped oscillation following the reflection spike is clear. In FIG. 8, the x axes show time and the y axes show correlation interference spike amplitude. FIG. 8B shows a D-OTDR trace obtained using the same apparatus as FIG. 8A, save that differential subsequences in accordance with some embodiments were used. As can clearly be seen, the presence of the damped oscillation following the reflection spike is substantially reduced.

When differential subsequences are used, the mathematical operations required for the cross-correlation are altered. Taking an example where the original sequences are a pair of complementary sequences (for example, Golay sequences) g1(i) and g2(i), i=0 to Ns/2−1. The derived sequences are g1′(i) and g2′(i):

g1′(2*i)=g1(i), g1′(2*i+1)=−g1(i),

g2′(2*i)=g2(i),g2′(2*i+1)=−g2(i),

The differential sequences are converted from bipolar sequences to pairs of unipolar subsequences (from +1, −1 to 1, 0) as described above, and sequences u1, v1, u2 and v2 are transmitted.

The sequences to be used for correlation with r1 and r2 are g1″(i) and g2″(i),

g1″(2*i)=g1(i), g1″(2*i+1)=0,

g2″(2*i)=g2(i), g2″(2*i+1)=0,

The correlation result is:

$$x c = \frac{c c o r r ( r 1 , g {1}^{′′} ) + c c o r r ( r 2 , g {2}^{′′} )}{Ns \cdot 2}$$

Accordingly, the correlation result is:
xc(0)=+0.5
xc(1)=−0.5
xc(i)=0 for i=2 to Ns−1.

In an example where the original sequences are LFSR sequences, they are already unipolar (0, 1 values), so u1=g1 and u2=g2.

In the case of LFSR differential sequences, the original sequences are g1(i) and g2(i), i=0 to Ns/2−1.

The derived sequences are g1′(i) and g2′(i),

g1′(2*i)=g1(i), g1′(2*i+1)=NOT(g1(i)),

g2′(2*i)=g2(i), g2′(2*i+1)=NOT(g2(i)),

In this case they are already unipolar (0, 1 values), so u1=g1′ and u2=g2′.

The sequences to be used for correlation with r1 and r2 are g1″(i) and g2″(i),

g1″(2*i)=g1(i), g1″(2*i+1)=0,

g2″(2*i)=g2(i), g2″(2*i+1)=0,

And the correlation result is:

$$x c = \frac{c c o r r ( r 1 , g {1}^{′′} ) + c c o r r ( r 2 , g {2}^{′′} )}{Ns \cdot 2}$$

Accordingly, the correlation result is:
xc(0)=+0.5
xc(1)=−0.5
xc(i)=0 for i=2 to Ns−1.

Specifically for LFSR sequences it is possible to generate one or more different sequences g1, g2, . . . gx, each one with a different polynomial. The generalized correlation result is:

$$x c = \frac{c c o r r ( r 1 , g 1 ) + c c o r r ( r 2 , g 2 ) + ⋯ + ccorr ( r x , g x )}{Ns \cdot x}$$

And in case of differential transmission:

$$xc = \frac{c c o r r ( r 1 , g {1}^{′′} ) + c c o r r ( r 2 , g {2}^{′′} ) + ⋯ + ccorr ( r x , {gx}^{′′} )}{Ns \cdot x}$$

Using two or more LFSR sequences may improve the signal to noise ratio. Simulations show noise floor flattening with increasing numbers of sequence types.

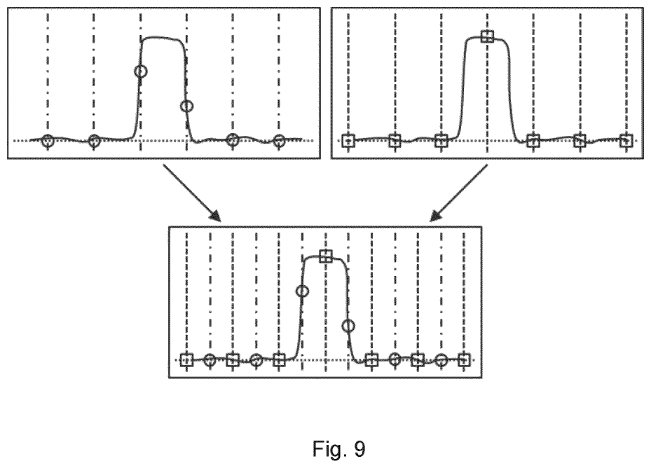

As mentioned previously with reference to FIG. 5, in some embodiments oversampling may be used. Sampling data at a sampling rate that is the same as the transmission bitrate may give sub-optimal results, for example, where sample points fall in bit transitions. The Nyquist frequency (which is the minimum sampling frequency to avoid loss of information) is Fs*2, so to improve signal reconstruction some embodiments may use two or more acquisitions and correlations with changing TX delay, and then combine the results. An example of multiple (here, 2) acquisitions with changing TX delay is shown in FIG. 9. In FIG. 9, both the circular data points and square data points are obtained by sampling at the TX frequency, with the square points obtained at a delay of ½ a sample relative to the circular points. The plot showing the combined measurement (with circular and square points) provides a more accurate result than either of the individual plots.

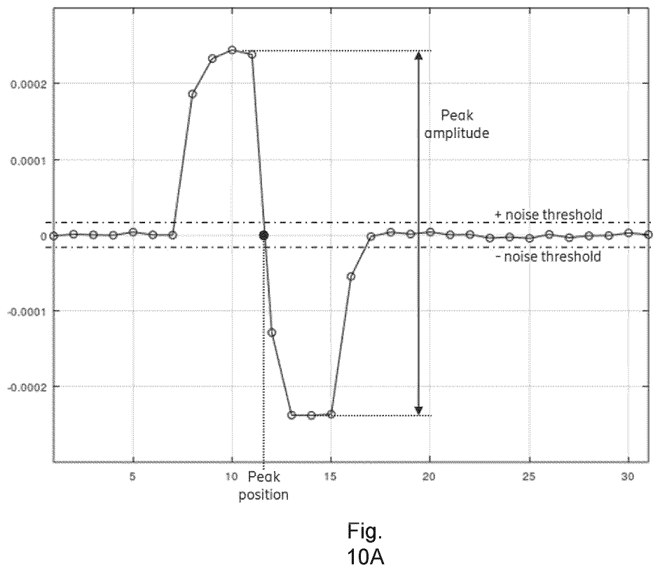

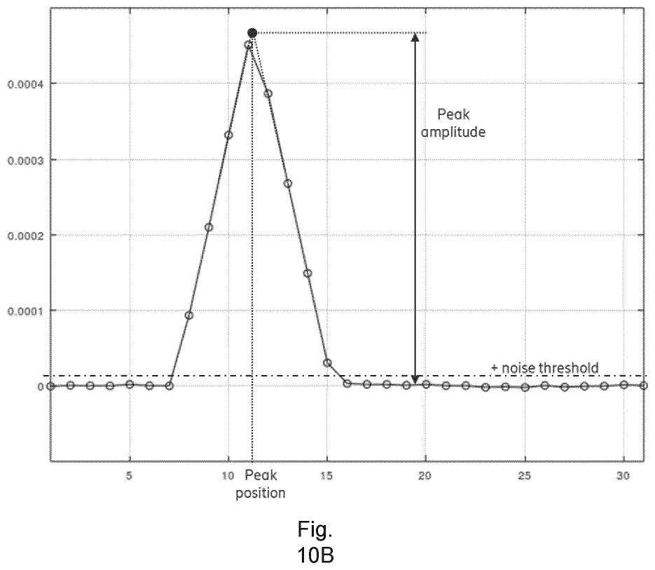

FIG. 10A is a plot showing measurement and correlation results. The plot was generated differential sequences and an oversampling ratio of 4. Circular cross-correlation was performed for each acquisition, then the results combined. In this example a peak detection algorithm was used to locate interference peaks (indicative of reflection points in the optical fibre) by searching for four samples with positive values followed by four samples with negative values, symmetrical with respect to zero. The peak amplitude is the difference between the positive value and the negative value, and the peak position can be found on the zero-crossing of the correlation. Accordingly, the delay or distance accuracy can be improved by linear interpolation. IN some embodiments, the peak detection algorithm may include some pre-processing, for example finding the noise threshold on correlation and excluding peaks below that threshold.

In some embodiments, to find correlation peaks when transmitting differential sequences an integration of the resulting correlation may be used. If xc is the result as shown on Error! Reference source not found.A, then the integrated correlation, xci, may be obtained as:

xci(0)=xc(0)

xci(i)=xc(i)+xci(i−1)
for i=1 to Ns.

Noisy measurements may result in integration providing less good results. To avoid problems, a noise threshold may be used to decide whether to integrate xc:

xci(i)=xc(i)+xci(i−1) if |xc(i)|>threshold(i)
xci(i)=xc(i) otherwise.

Error! Reference source not found. shows the result of integrating the correlation of Error! Reference source not found.A. To obtain the same peak amplitude, the result is multiplied by two and then divided by the number of samples per bit.

Embodiments may increase the effectiveness with which OTDR measurements may be obtained for optical fibres, for example, by minimising the amount of wasted time between measurement sequences. Embodiments may also provide improved sensitivity and robustness, and may allow sub-Nyquist sampling limitations to be avoided. In some embodiments these benefits may be provided without the need for high performance ADCs. Embodiments may also allow AC coupling artifacts to be cancelled, thereby further improving the accuracy of generated results.

Some embodiments of the methods and apparatuses described herein may allow fill patterns between sequences to be omitted, thereby improving the efficiency of the apparatus. In some embodiments, each subsequence to be used for OTDR may be repeated a given number of times, with one or more of the received subsequences discarded and with no fill pattern required. It is possible to perform correlation OTDR without the use of fill patterns between subsequences by analysing the subsequences in the transmitted subsequence and received subsequence utilising circular cross-correlation (instead of, for example, linear cross-correlation). In apparatuses not using circular cross-correlation, if there is no fill pattern, an overlap between consecutive sequences may result in no constructive interference spikes being generated (the constructive interference spikes are typically indicative of events in an optical fibre). In apparatuses not using circular cross-correlation, it may therefore be necessary to send a sequence, wait for all reflected bits to return (during which a fill pattern may be sent) then send a next sequence. With circular correlation the wait period is not necessary; valid results may be generated as long as the sent sequence is at least as long as the RTT. Performing correlation OTDR without the use of fill patterns may result in a decreasing of memory usage and measurement time.

In some embodiments, each measurement may be the merging of two or more measurements (phases) that are out of phase with each other by a fraction of a bit duration. As a consequence, the sensitivity and robustness of embodiments may be improved relative to systems that use sampling at the transmitted sequence bitrate and sub-Nyquist sampling limitations may be avoided. Contrary to oversampling at higher speed, merging measurements does not require a faster and more complex ADC to be used.

In some embodiments, differential subsequences may be used. The resulting balancing nature of the sequence and its differential behaviour may act to cancel out artifacts due to AC-coupling, and may support the use of standard transceivers. Non-linear integration processing may be applied after the circular cross-correlation to reverse the differentiation at a receiver.

It will be appreciated that aspects of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1-32. (canceled)

33. A method for performing correlation optical time domain reflectometry (OTDR) on an optical fibre, the method comprising:
generating a first signal, wherein the first signal comprises a sequence of optical radiation pulses based on a coded sequence, wherein the coded sequence comprises at least a first block and a second block, the first block comprising a plurality of repetitions of a first subsequence, and the second block comprising a plurality of repetitions of a second subsequence;
transmitting the first signal into an optical fibre;
receiving a returned signal of optical radiation backscattered and/or reflected from the optical fibre;
discarding at least one of the repetitions of the subsequences in the returned signal, to leave at least one remaining repetition of the subsequences; and
correlating the at least one remaining repetition of the subsequences from the returned signal with the first signal to obtain an OTDR measurement of the optical fibre.

34. The method of claim 33 wherein the coded sequence is based on a codeword.

35. The method of claim 34 wherein the codeword is a bipolar codeword and the first subsequence and second subsequence are a pair of unipolar codewords derived from the bipolar codeword.

36. The method of claim 35, wherein the coded sequence is further based on a second codeword and further comprises a third block and a fourth block, the third block comprising a plurality of repetitions of a third subsequence, and the fourth block comprising a plurality of repetitions of a fourth subsequence.

37. The method of claim 36, wherein the second codeword is a further bipolar codeword and the third subsequence and fourth subsequence are a pair of further unipolar codewords derived from the further bipolar codeword.

38. The method of claim 33, wherein the correlation of the at least one remaining repetition of the subsequences with the first signal utilises circular cross-correlation.

39. The method of claim 38, wherein the subsequences are differentiated to generate differential subsequences before transmission, and wherein the cross-correlation is performed between the differential subsequences transmitted in the first signal and differential subsequences received in the returned signal.

40. The method according to claim 33 wherein the at least one repetition of the subsequences in the returned signal that are discarded comprises the earliest received repetition in each block of the subsequences.

41. The method of claim 33, wherein the time duration of the discarded subsequences in each block is greater than or equal to a maximum round trip time (RTT) for the first signal in the optical fibre.

42. The method of claim 33, wherein the time duration for the remaining repetitions of the subsequences in the returned signal to be received is greater than or equal to a maximum round trip time (RTT) for the first signal in the optical fibre, or, the time duration for the subsequences in the returned signal to be received is greater than or equal to a maximum RTT for the first signal in the optical fibre.

43. The method of claim 33, wherein the transmission of the first signal comprises generating plural copies of the first sequence, applying different delays to the plural copies, and transmitting the plural copies.

44. The method of claim 33 wherein the first signal comprises DC signals.

45. An optical time domain reflectometry (OTDR) apparatus configured for performing correlation OTDR on an optical fibre, the OTDR apparatus comprising processing circuitry, a memory containing instructions executable by the processing circuitry, and one or more interfaces, whereby the OTDR apparatus is operable to:
generate a first signal, wherein the first signal comprises a sequence of optical radiation pulses based on a coded sequence, wherein the coded sequence comprises at least a first block and a second block, the first block comprising a plurality of repetitions of a first subsequence, and the second block comprising a plurality of repetitions of a second subsequence;
transmit the first signal into an optical fibre;
receive a returned signal of optical radiation backscattered and/or reflected from the optical fibre;
discard at least one of the repetitions of the subsequences in the returned signal, to leave at least one remaining repetition of the subsequences; and
correlate the at least one remaining repetition of the subsequences from the returned signal with the first signal to obtain an OTDR measurement of the optical fibre.

46. The OTDR apparatus of claim 45 wherein the coded sequence is based on a codeword.

47. The OTDR apparatus of claim 46 wherein the codeword is a bipolar codeword and the first subsequence and second subsequence are a pair of unipolar codewords derived from the bipolar codeword.

48. The OTDR apparatus of claim 47, wherein the coded sequence is further based on a second codeword and further comprises a third block and a fourth block, the third block comprising a plurality of repetitions of a third subsequence, and the fourth block comprising a plurality of repetitions of a fourth subsequence.

49. The OTDR apparatus of claim 48, wherein the second codeword is a further bipolar codeword and the third subsequence and fourth subsequence are a pair of further unipolar codewords derived from the further bipolar codeword.

50. The OTDR apparatus according to claim 45 wherein the at least one repetition of each of the subsequences in the returned signal that are discarded comprises the earliest received repetition in each block of the subsequences.

51. The OTDR apparatus of claim 50, wherein the time duration for the remaining repetitions of the subsequences in the returned signal to be received is greater than or equal to a maximum round trip time (RTT) for the first signal in the optical fibre, or, the time duration for the subsequences in the returned signal to be received is greater than or equal to a maximum RTT for the first signal in the optical fibre.

52. The OTDR apparatus of claim 45, wherein, for transmitting the first signal, the OTDR apparatus is configured to generate plural copies of the first sequence, apply different delays to each of the plural copies, and transmit the plural copies.
